(19) United States
(12) Patent Application Publication
(10) Pub. No.: US 2022/0410773 A1
(43) Pub. Date: Dec. 29, 2022

(54) VENTILATED SYSTEM FOR A VEHICLE SEAT

(71) Applicant: Faurecia India Private Limited, Bhosari (IN)

(72) Inventors: Abhijeet PHARATE, Old sangvi (IN); Yesh PRAJAPATI, Pimpri (IN)

(21) Appl. No.: 17/853,831

(22) Filed: Jun. 29, 2022

(30) Foreign Application Priority Data
Jun. 29, 2021 (IN) 202121029252

(51) Int. Cl. B60N 2/56; F04D 29/42; F04D 17/08

(52) U.S. Cl. CPC B60N 2/5657; F04D 29/4226; F04D 17/08

(57) ABSTRACT

A ventilated system for a vehicle seat. The ventilated system includes a ventilator fan, a fan housing and a fixing member. The fan housing covers the ventilator fan, and the fixing member is adapted to be secured in or on a trim part of the vehicle seat. The fan housing or the fixing member includes a concentric ring element having a wall portion and an engaging element. The fixing member or the fan housing has an engaging portion adapted to engage with the engaging element of the concentric ring element. While engaging, the wall portion of the concentric ring element forms a wall around the airflow to avoid any air leakage from/in-between the engaging portion of the fixing member and fan housing.

### TECHNICAL FIELD

The present invention relates to a ventilated system for a vehicle seat. More specifically, the present invention relates to a fan assembly mounted on a vehicle seat.

### BACKGROUND

Ventilated seat system is designed to enhance occupant comfort by passing air through the covering of the seat or horizontally through the seat itself. Generally, in the ventilated seat system, a fan assembly is mounted inside the cushioning of the seat and directs the air from the seat towards the vehicle interior. The fan assembly may include a housing in which the fan with other motors and fastening elements are arranged. The fan is fixed with the seat system with the help of screws, lugs etc. In the riding condition, the fan assembly may tend to disassemble and may lead to misfunctioning of the fan. Usually, the screws or the fasteners used to assemble the fan assembly may loosen up and may cause damage to the seats as well.

In such cases, the entire seat must be dismantled to repair the fan assembly and may consume a lot of time. Therefore, there is a need for fan assembly, which may overcome a few or all the problems of the prior art.

### SUMMARY

An object of the present invention is to provide a ventilated system for a vehicle seat.

Another object of the present invention is to provide a ventilated system for a vehicle seat, which is easy to assemble and robust in construction.

Yet another object of the present invention is to provide a ventilated system for a vehicle seat, which uses Poka yoke method to have right assembly and thereby avoiding mismatch.

One more object of the present invention is to provide a positive lock in the fan assembly thereby preventing unlock of the fan assembly due to vibration in dynamic condition.

According to at least some embodiments of the present invention, there is provided with a seat ventilated system for a vehicle seat. The ventilated system includes a ventilator fan, a fan housing and a fixing member.

The ventilator fan may include an air inlet and an air outlet and is adapted to rotate to suck-in an airflow into the air inlet and to pass it through the air outlet. The fan housing may cover the ventilator fan. The fan housing has a first housing portion and a second housing portion connectable to each other by any clipping or fastening means, the ventilator fan is placed within the first and the second housing portions. In an embodiment, the first housing portion or the second housing portion of the fan housing has a flexible tab and the fixing member has a protruded portion configured such that the flexible tab is adapted to lock with the protruded portion.

In another embodiment, the first housing portion or the second housing portion of the fan housing has a protruded portion and the fixing member has a flexible tab configured such that the protruded portion is adapted to lock with the flexible tab. Further, the fan housing may include a first opening arranged in correspondence with the air inlet or the air outlet.

The fixing member may be adapted to secured in or on a trim part or cushioning part of the vehicle seat. The fixing member has a second opening arranged in correspondence with the air inlet or air outlet.

The fan housing or the fixing member may include a concentric ring element comprising a wall portion and an engaging element. Similarly, the fixing member or the fan housing has an engaging portion adapted to engage with the engaging element of the concentric ring element. While engaging, the wall portion of the concentric ring element may form a wall around the airflow to avoid any air leakage from/in-between the engaging portion of the fixing member and fan housing.

The concentric ring element may be arranged around the first opening/second opening or on or in the contour of the first opening/second opening. The first opening and the concentric ring element is arranged in or on the first housing portion. The engaging portion may be arranged around the second opening/first opening or on or in the contour of the second opening/first opening. The engaging element of the concentric ring element is a L-shaped slot or an arm, and wherein the engaging portion is an arm or a L-shaped slot adapted to engage with the L-shaped slot or the arm of the engaging element of the concentric ring element.

In an embodiment, the wall portion of the concentric ring element is an inner ring and the engaging element of the concentric ring element is an outer ring having the L-shaped slot or the arm. In another embodiment, the wall portion of the concentric ring element is an outer ring and the engaging element of the concentric ring element is an inner ring having the L-shaped slot or the arm.

### BRIEF DESCRIPTION OF THE DRAWINGS

Other features and advantages of the invention will become apparent when reading the detailed description given below, purely by way of example and in a non-limitative manner, referring to the following figures:

FIG. 1 illustrates a schematic view of a seat ventilated system in accordance with an embodiment of the present invention;

FIG. 2 illustrates a top view of the seat ventilated system for a vehicle;

FIG. 3 illustrates a perspective view of a fan housing in accordance with an embodiment of the present invention;

FIG. 4 illustrates a schematic representation of a fixing member in accordance with an embodiment of the present invention; and

FIG. 5 illustrates another schematic representation of the fixing member.

### DETAILED DESCRIPTION

An embodiment of this invention, illustrating its features, will now be described in detail. The words “comprising, “having, “containing,” and “including,” and other forms thereof, are intended to be equivalent in meaning and be open-ended in that an item or items following any one of these words is not meant to be an exhaustive listing of such item or items or meant to be limited to only the listed item or items.

The terms “first,” “second,” and the like, herein do not denote any order, quantity, or importance, but rather are used to distinguish one element from another, and the terms “an” and “a” herein do not denote a limitation of quantity, but rather denote the presence of at least one of the referenced item.

The disclosed embodiments are merely exemplary of the invention, which may be embodied in various forms.

The present invention relates to a ventilated system for a vehicle seat. Specifically, to a fan assembly mounted on the vehicle seat. In the riding condition, the fan assembly may tend to disassemble and may lead to misfunctioning of the fan. Usually, the screws or the fasteners used to assemble the fan assembly may loosen up and may cause damage to the seats as well. In such cases, the entire seat must be dismantled to repair the fan assembly and may consume a lot of time. Hence a fan assembly is introduced which is mounted on a vehicle seat configuring a seat ventilated system. The fan assembly may be arranged inside the cushioning of the seat with an air outlet directing the air towards the vehicle interior.

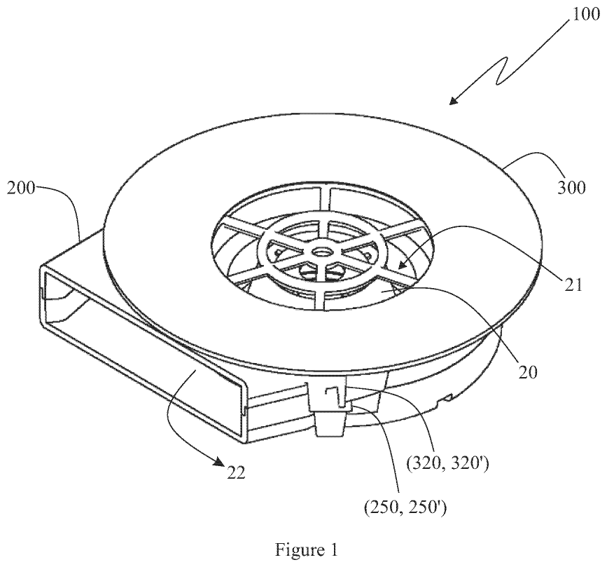

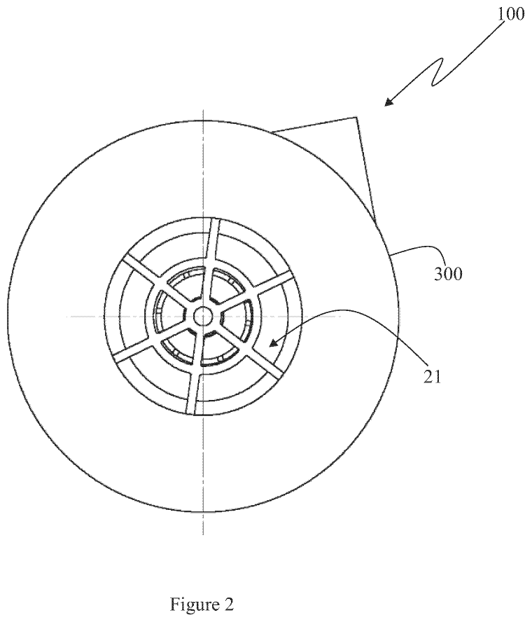

Referring now to FIGS. 1 and 2, a ventilated system (100) for a vehicle seat in accordance with an embodiment of the present invention is illustrated. The ventilated system (100) includes a ventilator fan (20), a fan housing (200) and a fixing member (300).

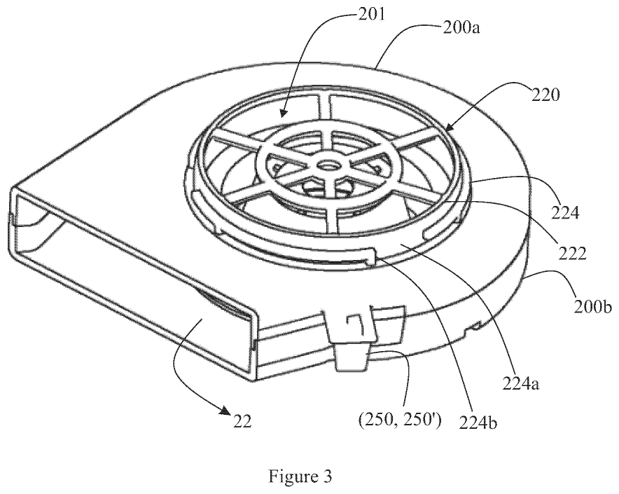

The ventilator fan (20) includes an air inlet (21) and an air outlet (22) and is adapted to rotate to suck-in an airflow into the air inlet (21) and to pass it through the air outlet (22) and directed towards the vehicle interior through the vehicle seat as shown in FIG. 1. In the present embodiment, the fan housing (200) covers the ventilator fan (20). Referring now to FIG. 3, The fan housing (200) has a first housing portion (200a) and a second housing portion (200b) connectable to each other by any clipping or fastening means. It may be obvious to a person skilled in the art to adjoin the first housing portion (200a) and the second housing portion (200b) by any fastening methods. The ventilator fan (20) is placed within the first and the second housing portions (200a, 200b). Further, the fan housing (200) is having a first opening (201) arranged in correspondence with the air inlet (21) or at the air outlet (22). The first opening (201) can be configured either at the air inlet (21) or the air outlet (22).

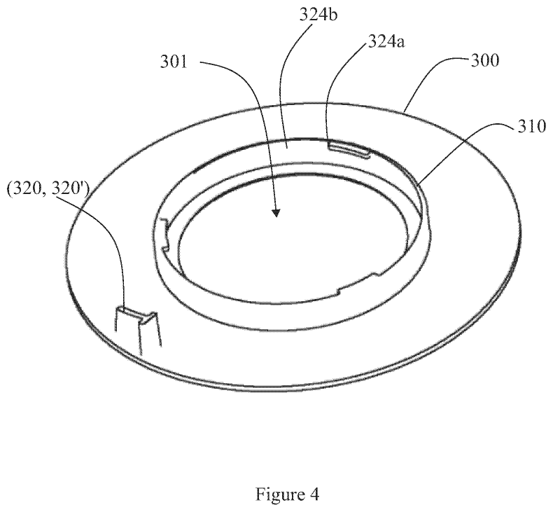

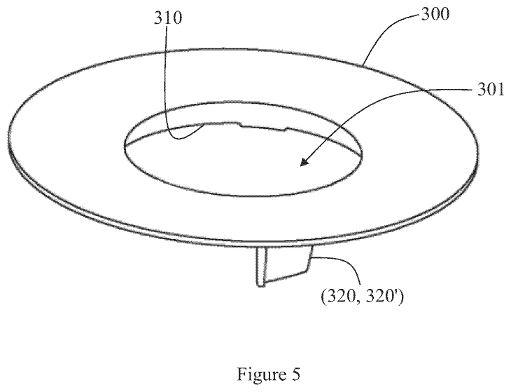

Referring again to FIG. 1, the fixing member (300) is secured in or on a trim part or cushioning part of the vehicle seat. In the present embodiment, the fixing member (300) is a ring like structure arranged on the cushioning part of the vehicle seat. The fixing member (300) is adapted to engage with the fan housing (200). Specifically, in an embodiment as shown in FIG. 1, the first housing portion (200a) or the second housing portion (200b) of the fan housing (200) has a flexible tab (250) and the fixing member (300) has a protruded portion (320) configured such that the flexible tab (250) is adapted to lock with the protruded portion (320). In another embodiment (not shown), the first housing portion (200a) or the second housing portion (200b) of the fan housing (200) has a protruded portion (250′) and the fixing member (300) has a flexible tab (320′) configured such that the protruded portion (250′) is adapted to lock with the flexible tab (320′). The fixing member (300) has a second opening (301) arranged in correspondence with the air inlet (21) or the air outlet (22) as shown in FIGS. 4 and 5.

In the present embodiment as shown in FIGS. 1 and 2, the fan housing (200) includes a concentric ring element (220) having a wall portion (222) and an engaging element (224). The concentric ring element (220) is arranged around the first opening (201) or on or in the contour of the first opening (201). The first opening (201) and the concentric ring element (220) is arranged in or on the first housing portion (200a). The concentric ring element (220) act as guiding and locating member for the fan assembly.

Further referring to FIGS. 4 and 5, the fixing member (300) has an engaging portion (310) adapted to engage with the engaging element (224) of the concentric ring element (220). The engaging portion (310) is arranged around the second opening (301) or on or in the contour of the second opening (301).

When the engaging portion (310) engages with the engaging element (224), the wall portion (222) of the concentric ring element (220) forms a wall around the airflow to avoid any air leakage from/in-between the engaging portion (310) of the fixing member (300) and the fan housing (200).

The engaging element (224) of the concentric ring element (220) is an L-shaped slot (224a) or an arm (224b), and the engaging portion (310) is an arm (324a) or a L-shaped slot (324b) respectively. The arm (324a) or the L-shaped slot (324b) of the engaging portion (310) is adapted to engage with the corresponding L-shaped slot (224a) or the arm (224b) of the engaging element (224) of the concentric ring element (220).

In an embodiment as shown in FIG. 3, the wall portion (222) of the concentric ring element (220) is an inner ring and the engaging element (224) of the concentric ring element (220) is an outer ring having the L-shaped slot or the arm.

In another embodiment, the wall portion (222) of the concentric ring element (220) is an outer ring and the engaging element (224) of the concentric ring element (220) is an inner ring having the L-shaped slot or the arm.

In a further embodiment (not shown), the fixing member (300) includes the concentric ring element (220) having the wall portion (222) and the engaging element (224). In such embodiment, the concentric ring element (220) is arranged around the second opening (301) or on or in the contour of the second opening (301). The concentric ring element (220) act as guiding and locating member for the fan assembly.

In such embodiment, the fan housing (200) has an engaging portion (310) adapted to engage with the engaging element (224) of the concentric ring element (220). The engaging portion (310) is arranged around the first opening (201) or on or in the contour of the first opening (201).

When the engaging portion (310) engages with the engaging element (224), the wall portion (222) of the concentric ring element (220) forms a wall around the airflow to avoid any air leakage from/in-between the engaging portion (310) of the fixing member (300) and fan housing (200).

In the present embodiment, a rotation of 20 deg of the fan housing (200) or the fixing member (300) ensures positive locking between the engaging portion (310) and the engaging element (224). This prevents unlocking of the fan assembly due to vibration in dynamic condition.

Therefore, this embodiment has the advantage of providing a seat ventilated system for a vehicle. The seat ventilated system is easy to assemble and robust in construction. Further the present embodiment uses Poka yoke method to have right assembly and thereby avoiding mismatch during assembling. Also, the present embodiment provides a positive lock in the fan assembly thereby preventing unlock of the fan assembly due to vibration in dynamic condition.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The embodiments were chosen and described in order to best explain the principles of the present invention and its practical application, and to thereby enable others skilled in the art to best utilize the present invention and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the scope of the claims of the present invention.

We claim:

1. A ventilated system for a vehicle seat, the ventilated system comprising:
a ventilator fan comprising an air inlet and an air outlet and is adapted to rotate to suck-in an airflow into the air inlet and to pass it through the air outlet;
a fan housing covering the ventilator fan, the fan housing comprising a first opening arranged in correspondence with the air inlet or the air outlet;
a fixing member adapted to be secured in or on a trim part or cushioning part of the vehicle seat, the fixing member has a second opening arranged in correspondence with the air inlet or air outlet; and
wherein the fan housing or the fixing member comprises a concentric ring element comprising a wall portion and an engaging element and the fixing member or the fan housing has an engaging portion adapted to engage with the engaging element of the concentric ring element and the wall portion of the concentric ring element forms a wall around the airflow to avoid any air leakage from/in-between the engaging portion of the fixing member and fan housing.

2. The seat ventilated system as claimed in claim 1, wherein the concentric ring element is arranged around the first opening/second opening or on or in the contour of the first opening/second opening.

3. The seat ventilated system as claimed in claim 1, wherein the engaging portion is arranged around the second opening/first opening or on or in the contour of the second opening/first opening.

4. The seat ventilated system as claimed in claim 1, wherein the fan housing has a first housing portion and a second housing portion connectable to each other by any clipping or fastening means, the ventilator fan is placed within the first and the second housing portions.

5. The seat ventilated system as claimed in claim 1, wherein the first opening and the concentric ring element is arranged in or on the first housing portion.

6. The seat ventilated system as claimed in claim 1, wherein the first housing portion or the second housing portion of the fan housing has a flexible tab and the fixing member has a protruded portion configured such that the flexible tab adapted to lock with the protruded portion.

7. The seat ventilated system as claimed in claim 1, wherein the first housing portion or the second housing portion of the fan housing has a protruded portion and the fixing member has a flexible tab configured such that the protruded portion adapted to lock with the flexible tab.

8. The seat ventilated system as claimed in claim 1, wherein the engaging element of the concentric ring element is a L-shaped slot or an arm, and wherein the engaging portion is an arm or a L-shaped slot adapted to engage with the L-shaped slot or the arm of the engaging element of the concentric ring element.

9. The seat ventilated system as claimed in claim 1, wherein the wall portion of the concentric ring element is an inner ring and the engaging element of the concentric ring element is an outer ring having the L-shaped slot or the arm.

10. The seat ventilated system as claimed in claim 1, wherein the wall portion of the concentric ring element is an outer ring and the engaging element of the concentric ring element is an inner ring having the L-shaped slot or the arm.
